(19) United States
(12) Patent Application Publication
(10) Pub. No.: US 2007/0112692 A1
(43) Pub. Date: May 17, 2007

(54) Drawing Take Off System

(76) Inventors: Cindy Bolduc, Winnipeg (CA); Miguel Carrasco, Winnipeg (CA); Bob James Green, Winnipeg (CA); Lam Nguyen, Winnipeg (CA); Lyle Mustard, Headingly (CA); Mike Nicholson, Winnipeg, MN (US); Suresh Jayaraman, Winnipeg (CA); Rachelle Thibodeau, Winnipeg (CA)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/553,629

(22) Filed: Oct. 27, 2006

Related U.S. Application Data
(60) Provisional application No. 60/732,458, filed on Nov. 1, 2005.

(51) Int. Cl. G06F 17/00

(52) U.S. Cl. 705/400

(57) ABSTRACT

A drawing take off system itemizes components shown on a paper drawing. The take off system includes a sleeve for holding a standard pen, a computer having a software module, and an interface connection between the sleeve and the computer. The software module maintains a list of each component model shown on the drawing. The sleeve includes a pen stroke switch for counting pen strokes and a component selection switch for selecting a component model from the component model list compiled in the software module. As an estimator marks components on the paper drawing, the take off system counts pen strokes for each individual component of each model of component marked on the paper project drawing by the estimator and calculates the cost for all of the components taken off of the paper drawing.

### RELATED APPLICATIONS

This application claims the benefit of priority of U.S. provisional application Ser. No. 60/732,458, filed Nov. 1, 2005, which is relied on and incorporated herein by reference.

### FIELD OF THE INVENTION

The present invention relates to a drawing take off system and drawing take off method for estimating the price of building components or other components shown on a paper drawing of a construction project.

### BACKGROUND OF THE INVENTION

For a manufacturer's representative, one of the most time intensive parts of the bid process for a construction project is selecting and pricing all of the manufacturer's components shown on the paper drawing of the construction project. In order to submit a bid for the construction project, the manufacturer's representative or estimator must accurately estimate the cost of the manufacturer's components required for the construction project. In order to estimate the cost of the manufacturer's components, the manufacturer's representative must “take off” all of the manufacturer's components from the paper drawing of the construction project.

In many cases the project drawing may include a number of different models of components from a single manufacture where each component model has a different price. Thus the estimator must not only take off all of the components from the project drawing, but the estimator must also keep track of how many components of each model have been taken off the drawing in order to calculate the total price of all of the components. This is an arduous task that requires many hours of manual labor. Many projects that are bid are not won by the manufacture's representative, so he or she must be able to bid as many projects as possible, while realizing only a certain percentage for a success rate.

Components may be taken off using a drawing digitizer pad. Existing drawing digitizers require a large digitizing pad to accommodate the project drawing. Such digitizers have an electromagnetic field and a transducer interruption to register the click of the digitizing pen on the project drawing. The need for a digitizing pad makes such existing solutions expensive and mobility restrictive. Further, the digitizing pen does not leave a mark on the paper project drawing, but only registers the coordinates on the digitizing pad. Because the “take off” process requires recording each component taken off the paper project drawing as well as recording the component in software, the lack of an ink mark on the paper project drawing does not allow the estimator to keep track of where he or she is on the paper project drawing.

Marking the paper project drawing could be accomplished by adding a custom ink cartridge to the digitizing pen. Such a custom ink cartridge may be hard to source and obtain, and a custom ink cartridge add to the digitizing pen does not solve the problem of the cost and inconvenience of a large digitizing pad.

Therefore, a need exists for a drawing take off system and a drawing take off method that allows an estimator to take off a manufacturer's components from a paper project drawing accurately.

### SUMMARY OF THE INVENTION

To overcome the problems of the prior art, the present invention is a drawing take off system comprising a sleeve for holding a standard pen or marker that is connected to a computer having a software module. The software module maintains a list of each model of component required for the project, counts pen strokes for each individual component model taken off of the paper project drawing by the estimator, and calculates the cost for all of the components taken off of the paper project drawing.

Because the sleeve accepts a standard pen or marker, the pen can be quickly and easily interchanged thereby allowing for changes in ink color or simply replacement of an empty pen. The sleeve has switches or other means for registering the selection of each of the manufacturer's component models on the drawing and for counting the number of pen strokes for each component of each component model on the paper project drawing. Particularly, the sleeve has manually operated buttons or micro switches to select a component model and to count pen strokes. Alternatively, the sleeve may use other actuators for selecting the component models and for counting pen strokes, including without limit, pressure sensors, strain gauges, magnetic sensors, proximity sensors, sonar sensors, or other sensors or switches known to those skilled in the art.

The outputs from the micro switches or other sensors are connected to the computer via a wired or wireless connection. Particular, the output of the micro switches or other sensors may be connected to the computer via a USB port, an infrared port, a bluetooth port, or any other communication port known to those of ordinary skill in the art.

The computer used in connection with the present invention may be a standard desktop personal computer but is preferably a laptop computer or a tablet computer with a touch screen.

The computer of the present invention includes a software module that maintains a list of each component model to be taken off of the paper project drawing, that counts pen strokes for each component of each component model taken off of the paper project drawing, and that calculates the total cost of all of the components taken off of the paper project drawing. Consequently, the estimator's job is simplified because the computer keeps track of the number of each component model that the estimator marks off of the paper project drawing. Further, once all of the components of each component model have been marked off of the paper project drawing, the software module calculates the total cost of all of the components taken off the paper project drawing. Such a drawing take off system and drawing take off method not only speeds up the process of taking components off of the paper project drawing, but also increases the accuracy of the estimator's estimate because the pen marks on the paper project drawing provide a clear indication that all of the components have been taken off and because the computer does the final cost calculation for all of components taken off of the paper project drawing.

Further objects, features and advantages will become apparent upon consideration of the following detailed description of the invention when taken in conjunction with the drawing and the appended claims.

### BRIEF DESCRIPTION OF THE DRAWINGS

FIG. 1 is a perspective drawing of a drawing take off system in accordance with the present invention.

FIG. 2 is a perspective drawing of a pen sleeve for the drawing take off system in accordance with the present invention.

FIG. 3 is a cross section view of the pen sleeve for the drawing take off system in accordance with the present invention taken along line 3-3 of FIG. 2.

FIG. 4 is an exploded view of the pen sleeve for the drawing take off system in accordance with the present invention.

FIG. 5 is a flow chart of a drawing take off method in accordance with the present invention.

FIG. 6 is screen shot showing an illustrative computer screen display used for entering project information for the drawing take off method in accordance with the present invention.

FIG. 7 is screen shot showing an illustrative computer screen display used for creating a list of component models for the drawing take off method in accordance with the present invention.

FIG. 8 is screen shot showing an illustrative computer screen display of for counting or taking off components for the drawing take off method in accordance with the present invention.

FIG. 9 is screen shot showing an illustrative computer screen display showing an estimate for the drawing take off method in accordance with the present invention.

FIG. 10 is screen shot showing an illustrative computer screen display for selecting the room schedule mode for a particular project for the drawing take off method in accordance with the present invention.

FIG. 11 is screen shot showing an illustrative computer screen display for entering project information in the room selection mode for the drawing take off method in accordance with the present invention.

FIG. 12 is screen shot showing an illustrative computer screen display for assigning components to rooms and floors in the room selection mode for the drawing take off method in accordance with the present invention.

FIG. 13 is screen shot showing an illustrative computer screen display of a parts list for the drawing take off method in accordance with the present invention.

### DETAILED DESCRIPTION OF THE INVENTION

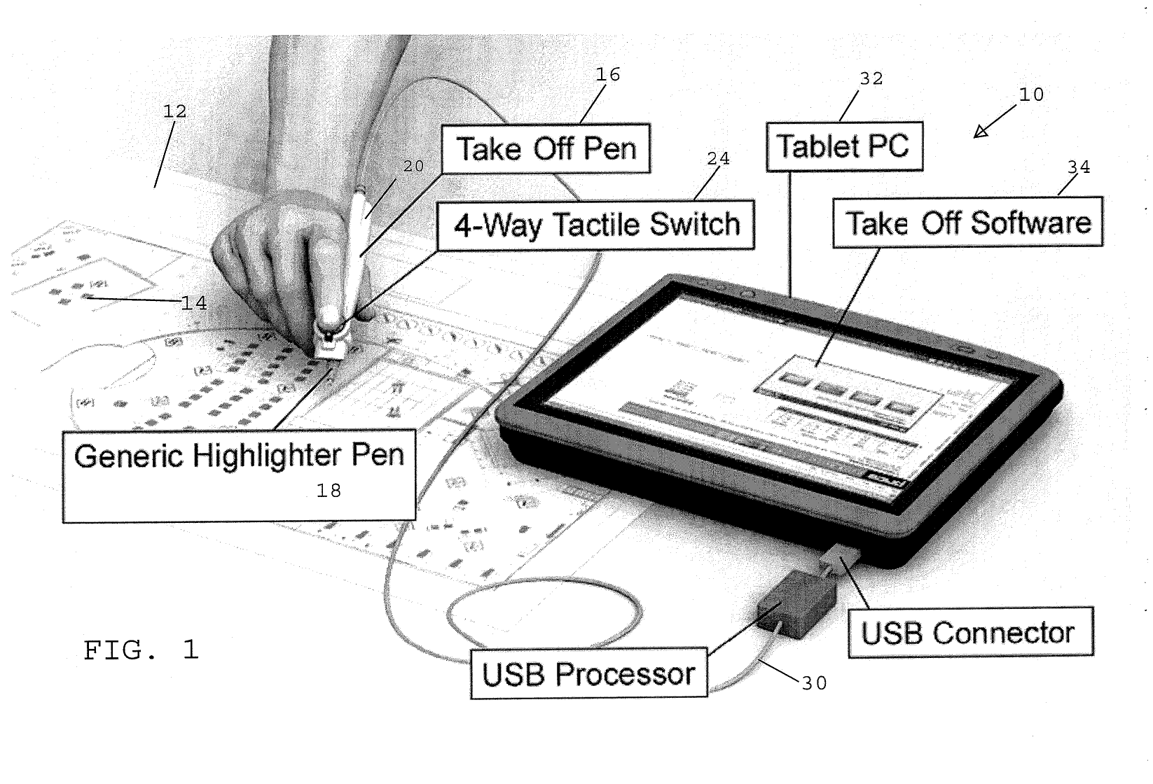

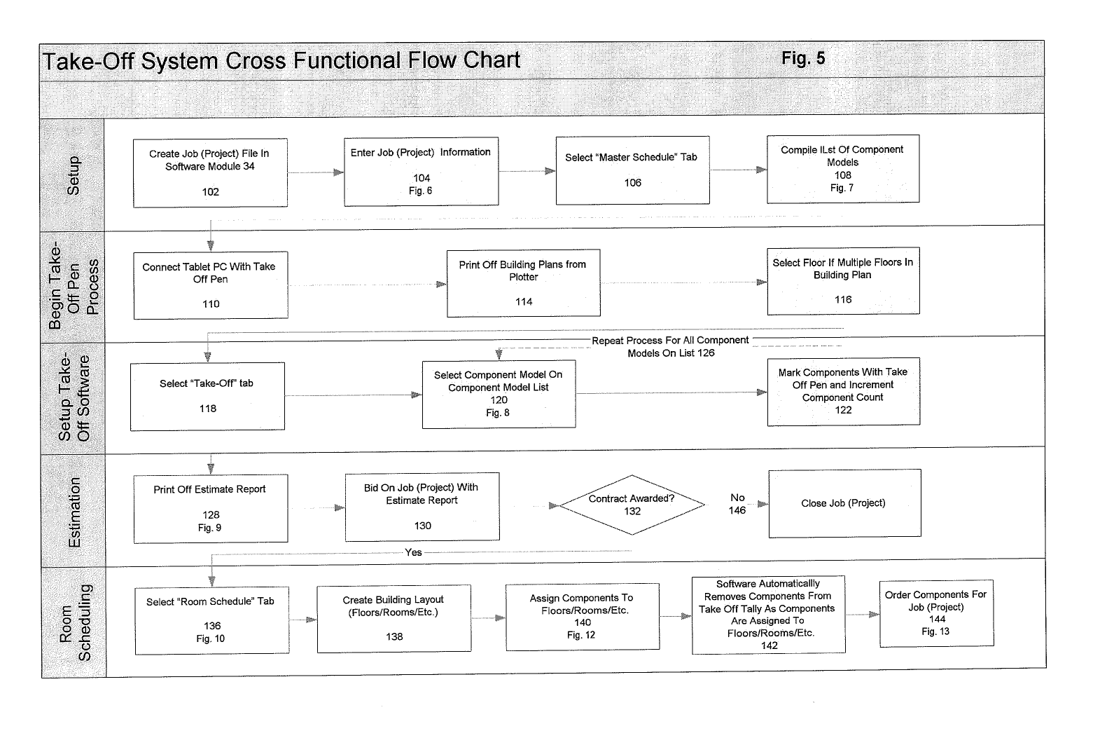

Referring now to the drawings, in which like reference numerals represent like parts throughout the several views, FIG. 1 discloses a drawing take off system 10, and FIG. 5 discloses a drawing take off method 100. The drawing take off system 10 is used to tabulate or “take off” components 14 shown on a paper project drawing 12. The paper project drawing 12 is typically the drawing for a construction project such as a building. The components 14 represented on the drawing 12 are the components used in the construction of the building, such as heating and air conditioning components (ducts, diffusers, fans, etc.), electrical devices (electric panels, outlets, light fixtures, etc.), and building materials (metal studs, sheet rock, ceiling panels, flooring, etc.).

In order for a manufacturer or a manufacturer's representative to bid on the building project for the components 14 sold by the manufacture, the manufacturer's representative must submit an estimate of the cost of supplying the manufacturer's components to the construction project contractor. In order to submit such an estimate, the manufacturer's representative or estimator, using the information from the paper drawing 12, must determine the different models of components 14 required, must count the number of each component model, and must calculate the total cost of all components 14 taken off of the paper drawing 12. Further, if the contractor awards the bid for the project to the manufacturer, the manufacturer's representative must prepare a parts list for ordering the needed components 14.

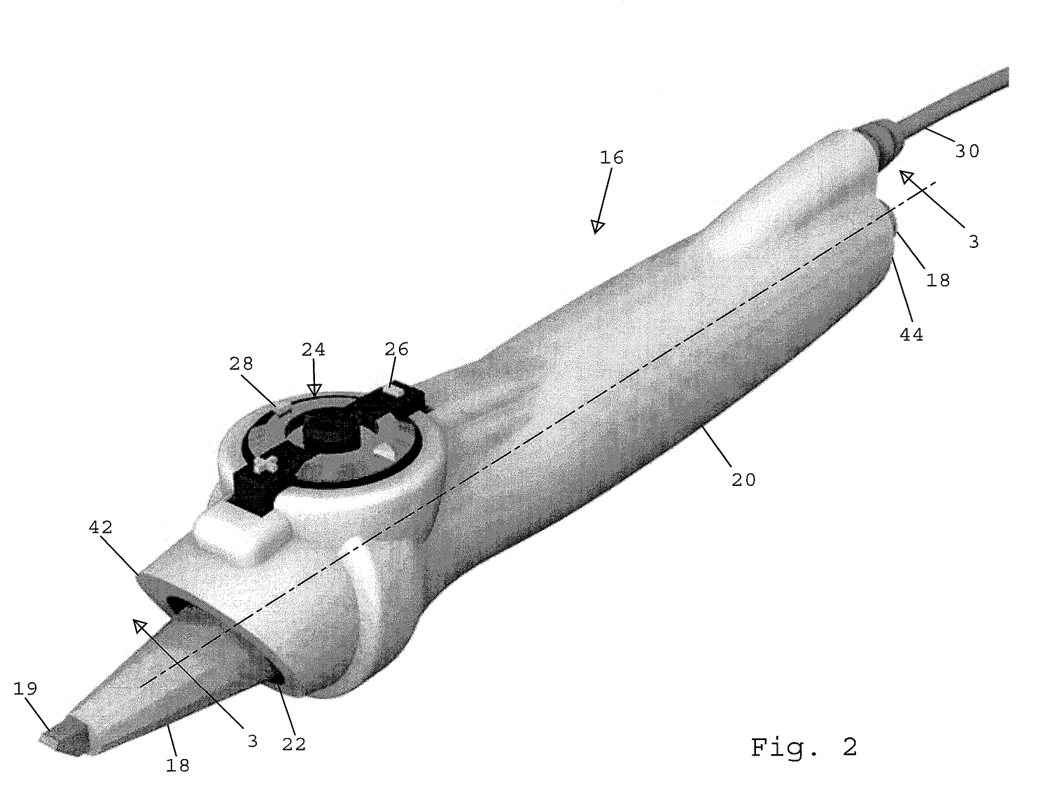

With referenced to FIG. 1, the drawing take off system 10 comprises a take off pen 16, an interface connection 30, and a computer 32 running a take off software module 34. As will be described in greater detail below in connection with the drawing take off method 100 shown in FIG. 5, the manufacturer's representative first uses a component selection signal switch 28 (FIG. 2) of a 4-way micro switch 24 on the take off pen 16 to select the model of component 14 required by the drawing 12 from a list of component models compiled in the software module 34. The manufacturer's representative then uses a pen stroke signal switch 26 (FIG. 2) of the 4-way micro switch 24 on the take off pen 16 to count each component 14 of each component model shown on the drawing 12. As each component is counted by activation of the pen stroke signal switch 26, the manufacturer's representative marks that component 14 on the drawing 12 with a marking pen 18 having a marking tip 19. The outputs from the component selection signal switch 28 and the pen stroke signal switch 26 of the 4-way micro switch 24 of the take off pen 16 are transmitted via the interface connection 30 to the software module 34 on the computer 32 where the software module 34 selects the particular component model required by the drawing 12 from the stored component model list and counts the number of pen strokes. Once all of the components 14 have been marked on the drawing 12, the software module 34 calculates the total cost of all of the components taken off of the drawing 12 and generates an estimate that can be submitted as part of bid to the contractor for the project.

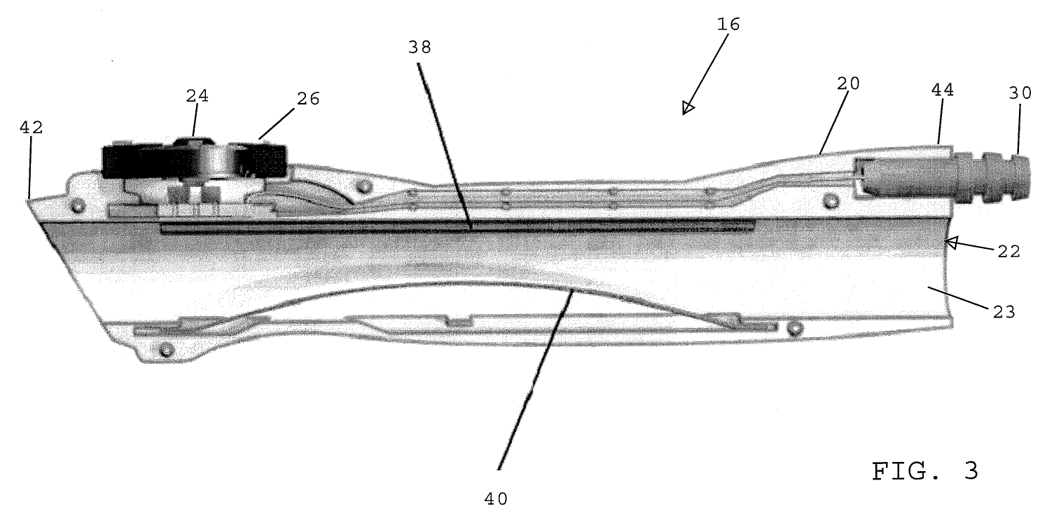

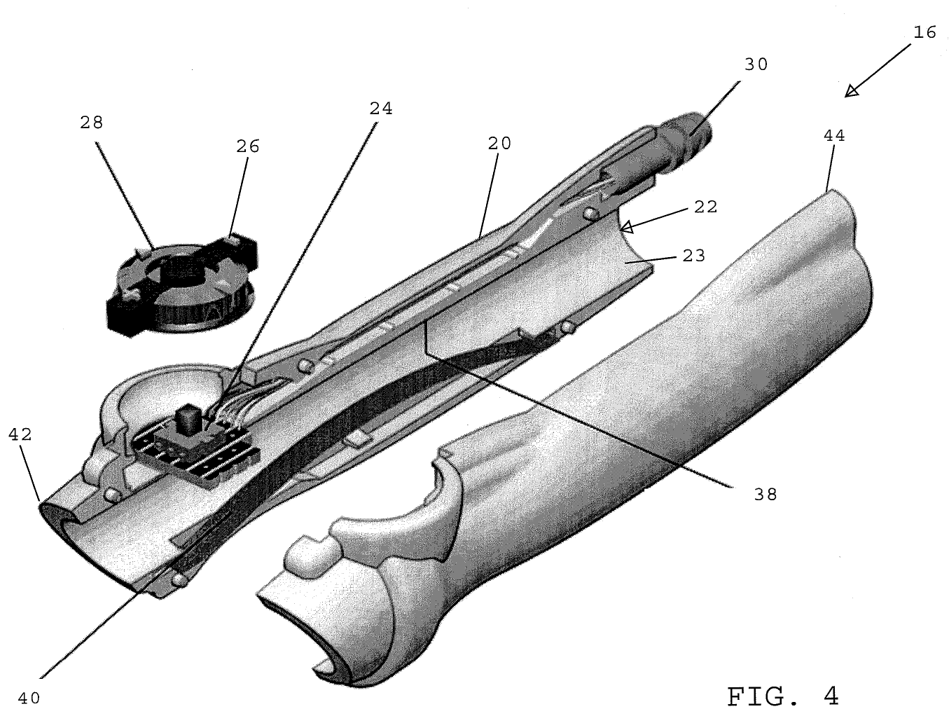

Turning to FIGS. 2-4, the take off pen 16 comprises a sleeve 20 with a distal end 42 and a proximal end 44. The sleeve 20 has a pen connector 22 that comprises an internal cylindrical chamber 23 extending the length of the sleeve 20 with a friction pad 38 and leaf spring 40 mounted within the chamber 23 (FIG. 3). The internal cylindrical chamber 23 encircles the pen 18, and the friction pad 38 and the leaf spring 40 together frictionally retain the marking pen 18 in the sleeve 20. While the cylindrical chamber 23 with the friction pad 38 and the leaf spring 40 is shown for connecting the marking pen 18 to the sleeve 20, clips or other temporary fasteners may be employed to connect the marking pen 18 to the sleeve 20. As shown in FIG. 2, the marking tip 19 of the pen 18 extends from chamber 23 at the distal end 42 of the sleeve 20. In order to connect the pen 18 to the sleeve 20, the marking tip 19 of the pen 18 is inserted into chamber 23 at the proximal end 44 of the sleeve 20 and slid until the marking tip extends from the chamber 23 at the distal end 42 of the sleeve 20 as shown in FIG. 2. In order to replace the pen 18, the pen 18 is pulled from the chamber 23, and another pen 18 is inserted into the chamber 23. Consequently, the pens can be easily changed to change ink color or to replace an empty pen.

The 4-way micro switch 24 is mounted on the sleeve 20 of the take off pen 16 near the distal end 42 of the sleeve 20. The location of the 4-way micro switch 24 allows the user to manipulate the 4-way micro switch 24 with the user's index finger when the user grips the take off pen 16 as shown in FIG. 1. By sliding the pen 18 within the chamber 23, the most comfortable position for the 4-way micro switch 24 can be achieved for a particular user. While a 4-way micro switch 24 is shown and described above, a 5-way micro switch could be substituted to provide an additional software control function by pressing the center of the switch. Such an additional control function may be used in a variety of ways to control the software module 34 as known to person of ordinary skill in the art.

The 4-way micro switch 24 includes the pen stroke signal switch 26 and the component selection signal switch 28. Manipulation of the component selection signal switch 28 generates a component selection signal on interface connection 30. The component selection signal has two states. When the component selection signal switch 28 is move in a first direction, the component selection signal indicates to the software module 34, via interface connection 30, that the software module 34 should step in a first direction on the component model list compiled in the software module 34 to select a particular component model. When the component selection signal switch 28 is move in a second direction, the component selection signal indicates to the software module 34, via interface connection 30, that the software module 34 should step in a second direction on the component model list compiled in the software module 34 to select a particular component model.

Manipulation of the pen stroke signal switch 26 generates a pen stroke signal on interface connection 30. The pen stroke signal has two states. When the pen stroke signal switch 26 is move in a first direction, the pen stroke signal indicates to the software module 34, via interface connection 30, that the software module 34 should increment the number of components 14 taken off of the drawing 12. When the pen stroke signal switch 26 is move in a second direction, the pen stroke signal indicates to the software module 34 that the software module 34 should decrement the number of components 14 taken off of the drawing 12.

While the pen stroke signal switch 26 is shown as a manually manipulated micro switch, the pen stroke signal switch 26 could be implemented by a sensor for sensing the stroke of the pen 18 on the paper drawing 12. Particularly, the pen stroke signal switch 26 could include without limit, pressure sensors, strain gauges, magnetic sensors, proximity sensors, sonar sensors, or other sensors or switches known to those skilled in the art for sensing the stroke of the pen 18 on the paper drawing 12.

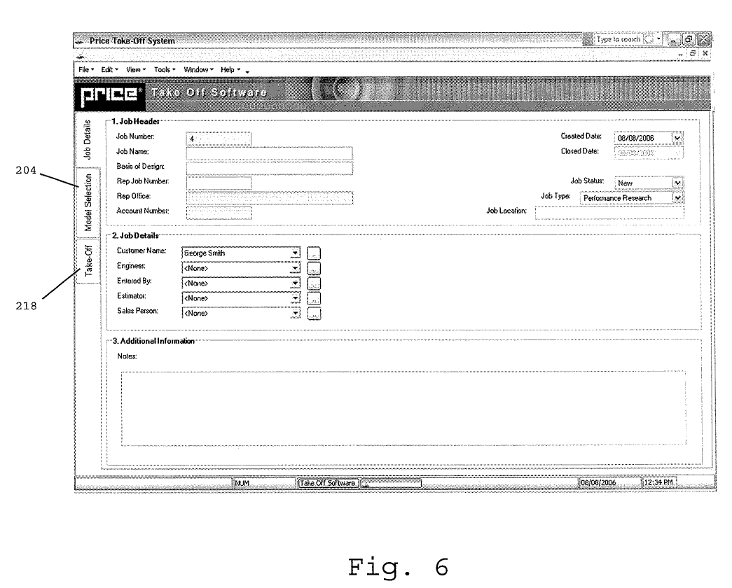

FIG. 5 shows the drawing take off method 100 in accordance with the present invention for estimating the cost of supplying components shown on the paper project drawing 12. The software module 34 on the computer 32 implements certain aspects of the drawing take off method 100. The drawing take off method 100 starts at step 102, where the user interacts with the software module 34 on computer 32 to create a job or project file for a project to be estimated. From step 102, the method 100 proceeds to step 104, where the user enters job or project information into the fields shown in FIG. 6.

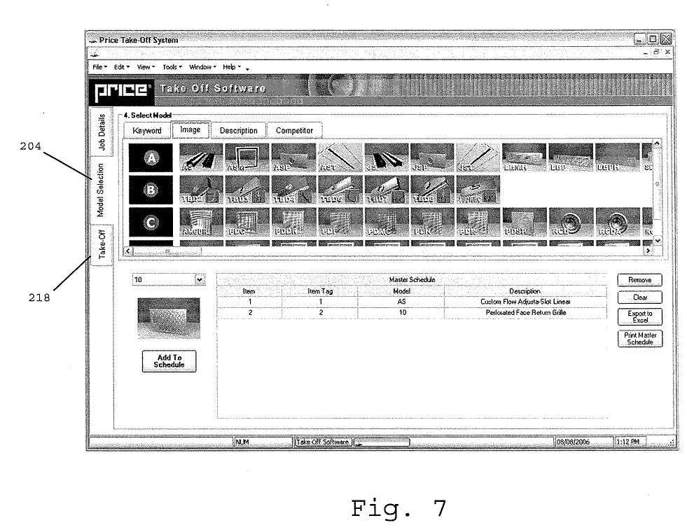

From step 104, the drawing take off method 100 proceeds to step 106. At step 106, the user selects the model selection tab 204 (FIG. 6). When the user selects the model selection tab 204 (FIG. 6), the drawing take off method 100 moves from step 106 to step 108, and the software module 34 displays the screen shown in FIG. 7. At step 108, and using the screen shown in FIG. 7, the user compiles a list of component models that are required by the drawing 12.

The drawing take off method 100 moves from step 108 to step 110, where the user connects the take off pen 16 to the computer 32. From step 110, the drawing take off method 100 moves to step 114, where the user prints the project or building plans, which include the paper drawing 12. Once the project or building plans are printed at step 114, the drawing take off method moves to step 116, where, in the case of a building, the user selects a particular floor of the building plans if the building has more than one floor.

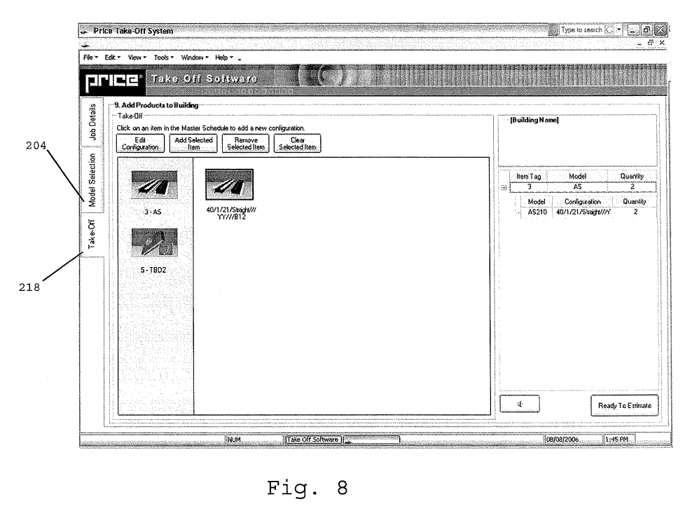

From step 116, the drawing take off method 100 moves to step 118, where the user selects take off tab 218 shown in FIG. 7. By selecting tab 218 in FIG. 7, the drawing take off method 100 moves to step 120, where the software module 34 displays the screen shown in FIG. 8. At step 120 the user, using the screen shown in FIG. 8 and the component selection signal switch 28 on the take off pen 16, selects the first component model from the component model list to be taken off of the drawing 12. Once the first component model has been selected from the component model list at step 120, the drawing take off method 100 moves to step 122. At step 122, the user marks each of the components 14 of the first component model on the drawing 12 with the pen 18 and uses pen stroke signal switch 26 on the take off pen 16 to increment the count in the software module 34 for the components 14 of the first component model on the drawing 12. Once all of the components of the first component model have been marked by the pen 18 and counted by the software module 34 at step 122, the drawing take off method 100 returns along path 126 to step 120, and the user selects the second component model from the list of component models using the screen shown in FIG. 8 and the component selection signal switch 28 on the take off pen 16. With the second component model selected, step 122 is repeated in order to count the number of components 14 of the second component model found on the drawing 12.

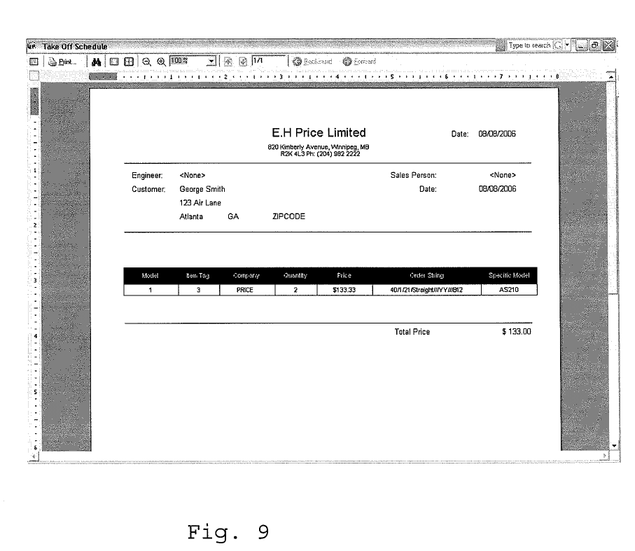

Once all of the components of the drawing 12 have been marked and counted, the drawing take off method 100 proceeds from step 122 to step 128, where the software module 34 calculates the cost of all the components taken off of the drawing 12 and prints an estimate report such as that shown in FIG. 9.

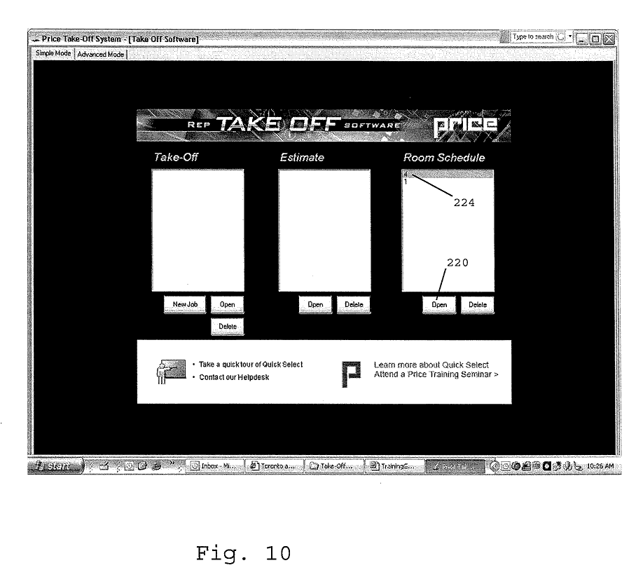

From step 128, the drawing take off method 100 moves to step 130, where the estimate report is submitted to the contractor in connection with bidding for the project shown in the drawing 12. Once the bid has been submitted at step 130, the drawing take off method 100 moves to decision step 132. At step 132, the contractor decides whether to accept the bid and award the contract or to reject the bid. If the bid is rejected, the drawing take off method 100 follows the “no” branch 146 to step 134, and the job or project file is closed. If on the other hand, the contract is awarded, the drawing take off method 100 follows the “yes” branch 148 from step 132 to step 136, where the user enables the room schedule function by opening one of the projects 224 shown in FIG. 10 by pressing button 220.

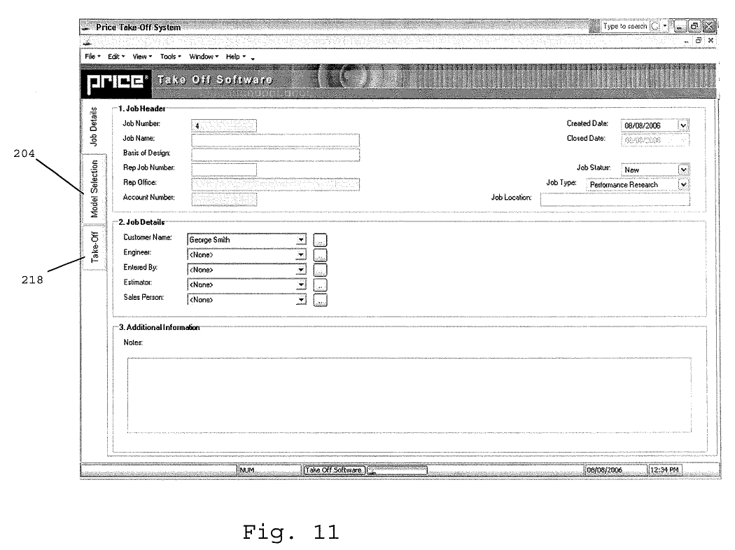

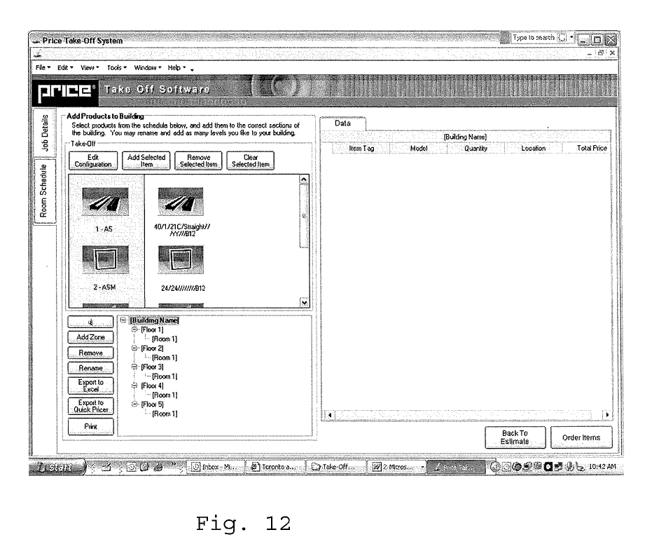

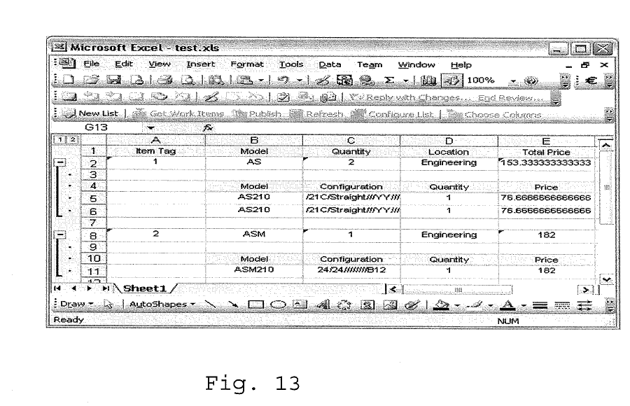

Selection of the room schedule function at step 136 displays the screen shown in FIG. 11, where additional information can be added about the awarded project. From step 136, the drawing take off method 100 moves to step 138. At step 138, the user creates a building layout. From step 138, the drawing take off method 100 moves to step 140, where the user can move components into the rooms or floors using the building layout that was created at step 138 (FIG. 12). From step 140, the drawing take off method 100 moves to step 142, where the software module 34 automatically removes components from the take off tally as the components are placed in the appropriate rooms and floors of the building layout created at step 138. Once the building layout has been completed (step 138) and the software module 34 has automatically tallied the components for the new floors and rooms (step 142), a parts list (FIG. 13) is created at step 144 for ordering the components for the job or project that has been awarded.

While this invention has been described with reference to preferred embodiments thereof, it is to be understood that variations and modifications can be affected within the spirit and scope of the invention as described herein and as described in the appended claims.

We claim:

1. A drawing take off system for itemizing components shown on a paper drawing comprising:
a. a sleeve for a pen including:
i. a connector for connecting the pen to the sleeve; and
ii. a sensor for recording the stroke of the pen on the paper drawing and generating a pen stroke signal in response to the pen stroke;
b. an interface connection; and
c. a digital computer having a software module for:
i. receiving the pen stroke signal via the interface connection;
ii. counting the pen strokes; and
iii. calculating the cost of the components taken off of the paper drawing.

2. The drawing take off system of claim 1, wherein the sleeve further includes a component selection switch for generating a component selection signal, wherein the software module includes a list of component models, and wherein the software module receives the component selection signal via the interface connection, selects a particular component model from the list of component models, and uses the selected component model for calculating the cost of the components taken off of the paper drawing.

3. The drawing take off system of claim 1, wherein the sensor for recording the stroke of the pen on the paper drawing and generating a pen stroke signal in response to the pen stroke comprises a manually operated switch.

4. The drawing take off system of claim 1, wherein the connector for connecting the pen to the sleeve comprises an internal cylindrical chamber with a friction pad for retaining the pen within the sleeve.

5. A drawing take off method for itemizing components shown on a paper drawing comprising the steps of:
a. connecting a pen to a sleeve wherein the sleeve includes:
i. a connector for connecting the pen to the sleeve; and
ii. a sensor for sensing the stroke of the pen on the paper drawing and generating a pen stroke signal in response to the pen stroke;
b. providing an interface connection from the sensor to a digital computer having a software module;
c. marking a component shown on the paper drawing with the pen; and
d. sensing the pen stroke with the sensor, generating a pen stroke signal, and transmitting the pen stroke signal via the interface connection to the software module in the digital computer wherein the software module:
i. receives the pen stroke signal via the interface connection;
ii. counts the pen strokes; and
iii. calculates the cost of the components taken off of the paper drawing.

6. The drawing take off method of claim 5, wherein the sleeve further includes a component selection switch for generating a component selection signal, wherein the software module includes a list of component models, and wherein the software module receives the component selection signal via the interface connection, selects a particular component model from the list of component models, and uses that selected component model for calculating the cost of the components taken off of the paper drawing.

7. A sleeve for a pen used to take off components shown on a paper drawing comprising:
a. a connector for connecting the pen to the sleeve; and
b. a sensor for recording the stroke of the pen on the paper drawing and generating a pen stroke signal in response to the pen stroke.

8. The sleeve of claim 7, wherein the sleeve further includes a component selection switch for generating a component selection signal.

9. The sleeve of claim 7, wherein the sensor for recording the stroke of the pen on the paper drawing and generating a pen stroke signal in response to the pen stroke comprises a manually operated switch.

10. The sleeve of claim 7, wherein the connector for connecting the pen to the sleeve comprises an internal cylindrical chamber with a friction pad for retaining the pen within the sleeve.
